(19) United States
(12) Patent Application Publication
(10) Pub. No.: US 2026/0084979 A1
(43) Pub. Date: Mar. 26, 2026

(54) METHOD FOR MANUFACTURING OXIDE PARTICLES COATED WITH AMINO GROUPS

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen, CN (CN)

(21) Appl. No.: 18/896,963

(22) Filed: Sep. 26, 2024

(51) Int. Cl. C01G 25/00; H01M 4/36; H01M 4/485; H01M 4/62

(52) U.S. Cl. CPC C01G 25/006; H01M 4/366; H01M 4/485; H01M 4/628; C01P 2002/54; C01P 2004/38; C01P 2004/80; C01P 2006/40

(57) ABSTRACT

includes the steps of: placing a plurality of first LLZO particles and a methanol into a wet mixer for mixing to form a first mixed slurry; then placing a tris (tris(hydroxymethyl)aminomethane) material and a tris(hydroxymethyl)aminomethane hydrochloride into the wet mixer for grinding and stirring to form a second mixed slurry and to cause that an outer surface of each of the first LLZO particles is coated with a hydroxide ion layer; then placing a dopamine hydrochloride into the wet mixer for mixing to form a third mixed slurry and to cause that a dopamine layer is coated on an outer surface of the hydroxide ion layer on each of the first LLZO particles. A CTAB (cetyltrimethylammonium bromide) surfactant is added into the third mixed slurry.

### FIELD OF THE INVENTION

The present invention is related to a battery electrode material, and in particular to a method for manufacturing oxide particles coated with amino groups.

### BACKGROUND OF THE INVENTION

A typical battery is formed by the electrodes (positive and negative) placed in an electrolyte. In the prior art, LLZO (lithium lanthanum zirconium oxide) material is added into the electrodes to increase the ionic conductivity. Because LLZO particles has a high ionic conductivity for lithium ions, when the lithium ions pass through the electrode, the lithium ions can be dispersed by the guiding of the dispersed LLZO particles. Therefore, the lithium ions can be evenly distributed inside the electrode, which avoids the abnormal accumulation of lithium ions in the electrode slurry to cause a side reaction.

However, the LLZO material is easy to perform a side reaction with other materials in the electrode during the manufacturing of the electrode, resulting in deterioration of the material in the electrode slurry.

### SUMMARY OF THE INVENTION

Accordingly, for improving above mentioned defects in the prior art, the object of the present invention is to provide a method for manufacturing oxide particles coated with amino groups, wherein multiple mixing stages are used in the present invention to replace the conventional single mixing stage. In the prior art, the LLZO particles, tris (tris(hydroxymethyl)aminomethane) and dopamine hydrochloride are mixed in only one single stage, which does not have an adequate reaction and the dopamine coverage is also lower and cannot provide effective protection for the LLZO particles. Therefore, in the present invention, the mixing process is divided into multiple stages to extend the whole reaction time, which can make the LLZO particles have a smaller size and a larger surface area to effectively and fully react with the tris and dopamine hydrochloride. As a result, the surface of the LLZO particle can be completely coated with a solid dopamine layer form by the dopamine material to protect the LLZO particle from moisture erosion. The LLZO particles coated with the solid dopamine layer have a high lithium ion conductivity and no reaction will be formed between the water and the LLZO particles in the manufacturing process of electrodes, which achieves a better manufacturing quality of the battery electrode material.

To achieve above object, the present invention provides a method for manufacturing oxide particles coated with amino groups, wherein the oxide particles are a plurality of composite LLZO particles; the method comprising the steps of: step A: placing a plurality of first LLZO particles and a methanol into a wet mixer for mixing and grinding at a first rotation speed to form a first mixed slurry; wherein the wet mixer has a plurality of zirconium balls for mixing and grinding to cause that the size of each of the first LLZO particles is smaller than 500 nm; step B: placing a tris (tris(hydroxymethyl)aminomethane, (HOCH₂)₃CNH₂) material and a tris(hydroxymethyl)aminomethane hydrochloride (NH₂C(CH₂OH)₃·HCl) into the wet mixer for grinding and stirring with the first mixed slurry to form a second mixed slurry and to cause that an outer surface of each of the first LLZO particles is coated with a hydroxide ion layer; wherein the hydroxide ion layer has a plurality of third OH⁻ ions; each of tris molecules in the tris material and the tris(hydroxymethyl)aminomethane hydrochloride has three OH⁻ ions which are a first OH⁻ ion, a second OH⁻ ion and the third OH⁻ ion; the first OH⁻ ions and the second OH⁻ ions of the tris molecules are bound to oxidizing functional groups on a corresponding first LLZO particle; and the third OH⁻ ions of the tris molecules extend outward to an outer side of the corresponding first LLZO particle to form the hydroxide ion layer on the corresponding first LLZO particle; wherein in the step B, after the tris material and the tris(hydroxymethyl)aminomethane hydrochloride are placed into the wet mixer, a rotation speed of the wet mixer is increased from the first rotation speed to a second rotation speed for grinding and stirring; step C: placing a dopamine hydrochloride ((HO)₂C₆H₃CH₂CH₂NH₂·HCl) into the wet mixer for mixing and grinding with the second mixed slurry to form a third mixed slurry which includes the composite LLZO particles; wherein the dopamine hydrochloride has a plurality of dopamine molecules; a polymerization triggered by dehydration is performed between OH⁻ ions of the dopamine molecules and the third OH⁻ ions of the hydroxide ion layer on a corresponding first LLZO particle, which causes that each of the first LLZO particles is bound to a plurality of corresponding dopamine molecules; the corresponding dopamine molecules are co-polymerized to form a dopamine layer coated on an outer surface of the hydroxide ion layer on the corresponding first LLZO particle; and each of the composite LLZO particles is formed by a corresponding first LLZO particle, a corresponding hydroxide ion layer and a corresponding dopamine layer; and wherein in the step C, the rotation speed of the wet mixer is decreased from the second rotation speed to a third rotation speed.

### BRIEF DESCRIPTION OF THE DRAWINGS

FIG. 1 is a steps flow diagram showing the process of the present invention.

FIG. 2 is a steps flow diagram showing the process of step A of the present invention.

FIG. 3 is a steps flow diagram showing the process of step B of the present invention.

FIG. 4 is a steps flow diagram showing the process of step C of the present invention.

FIG. 5 shows an application of the present invention.

FIG. 6 is a schematic view showing the full structure and a partial structure of the hydroxide ion layer of the present invention.

FIG. 7 is a schematic view showing the full structure of the composite LLZO particle of the present invention and the partial structure of the composite LLZO particle formed by the polymerization triggered by dehydration of the OH⁻ ion of the dopamine of the dopamine layer and the third OH⁻ ion of the hydroxide ion layer.

FIG. 8 is a schematic view showing a partial structure of the composite LLZO particle of the present invention, wherein the attractions are formed between the OH⁻ ion of the CTAB and dopamine and the third OH⁻ ion of the hydroxide ion layer.

FIG. 9 is a cross-section view showing the structure of the composite LLZO particle of the present invention.

FIG. 10 is a schematic view showing the structure of the composite LLZO particle coated with carbon nanotubes and nanoscale amorphous carbons.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

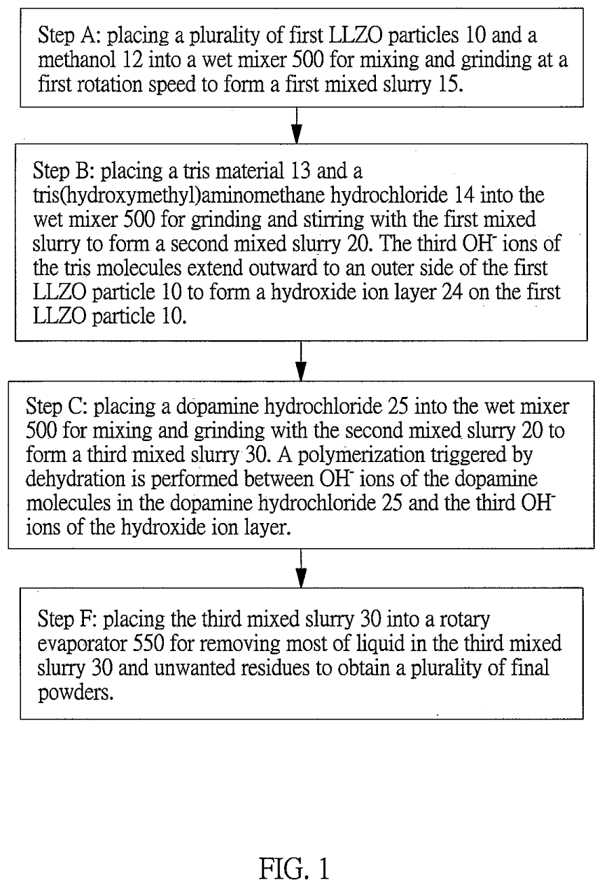

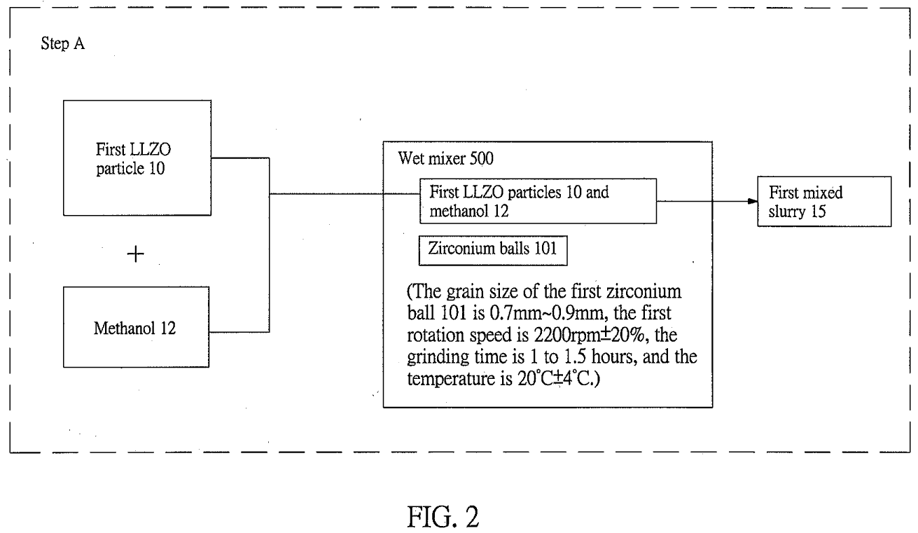

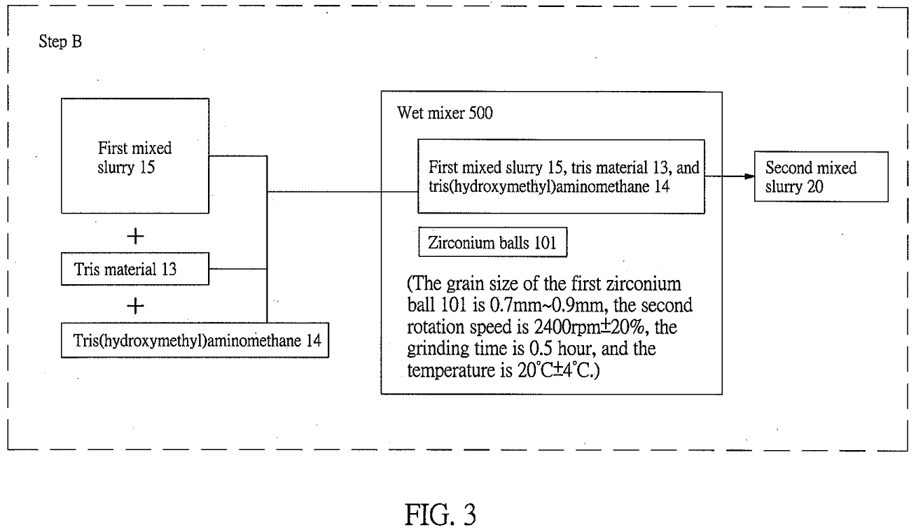

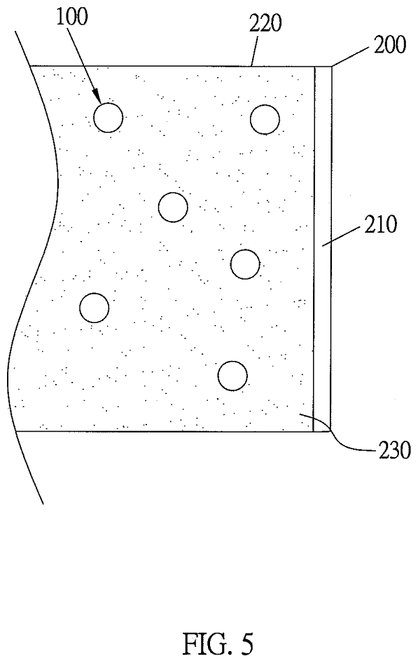

With reference to FIGS. 1 to 10, the present invention provides a method for manufacturing oxide particles coated with amino groups. The oxide particles are a plurality of composite LLZO particles 100. The composite LLZO particles 100 are used in an electrode of a solid-state or semi-solid battery. In the application, the composite LLZO particles 100 can be added into the electrode, in particular a positive electrode 200 of the solid-state or semi-solid battery. Referring to FIG. 5, the positive electrode 200 includes a substrate 210 for carrying the material of the positive electrode 200, and a positive electrode slurry layer 220 coated on the substrate 210. The positive electrode slurry layer 220 includes the composite LLZO particles 100 and a positive electrode slurry 230 which is used as a binder. A weight percentage of the composite LLZO particles 100 in an electrode slurry layer (in particular the positive electrode slurry layer 220) is 0.5wt%˜5wt%.

Referring to FIGS. 1 to 4, the method of the present invention comprises the following steps of:

Step A: placing a plurality of first LLZO particles 10 and a methanol 12 into a wet mixer 500 for mixing and grinding at a first rotation speed to form a first mixed slurry 15. Each of the first LLZO particles 10 is a cube having an irregular three-dimensional shape. Before the mixing and grinding of the wet mixer 500, a size of each of the first LLZO particles 10 is 2 μm˜10 μm.

Each of the first LLZO particles 10 is formed by LLZO (lithium lanthanum zirconium oxide, Li₇La₃Zr₂O₁₂) or LLZO doped with at least one metal (such as gallium(Ga)-doped LLZO (Li_{6.2}Ga_{0.8}La₃Zr₂O₁₂), aluminum(Al)-doped LLZO or barium(Ba)-doped LLZO.

A ratio of a total weight of the first LLZO particles 10 and a weight of the methanol 12 is 0.8˜1.2:4.

The wet mixer 500 has a plurality of zirconium balls 101 for mixing and grinding to cause that the size of each of the first LLZO particles 10 is smaller than 500 nm after the mixing and grinding. The first rotation speed of the wet mixer 500 is 2200 rpm±20%. Each of the first zirconium balls 101 has a grain size of 0.7 mm to 0.9 mm. A filling ratio of a total volume of the zirconium balls 101 is 70% to 90%, which is a ratio of the total volume of the zirconium balls 101 to a grinding volume of the wet mixer 500. A mixing and grinding time of the wet mixer 500 is 1 to 1.5 hours. An operation temperature of the wet mixer 500 is 20° C.±4° C.

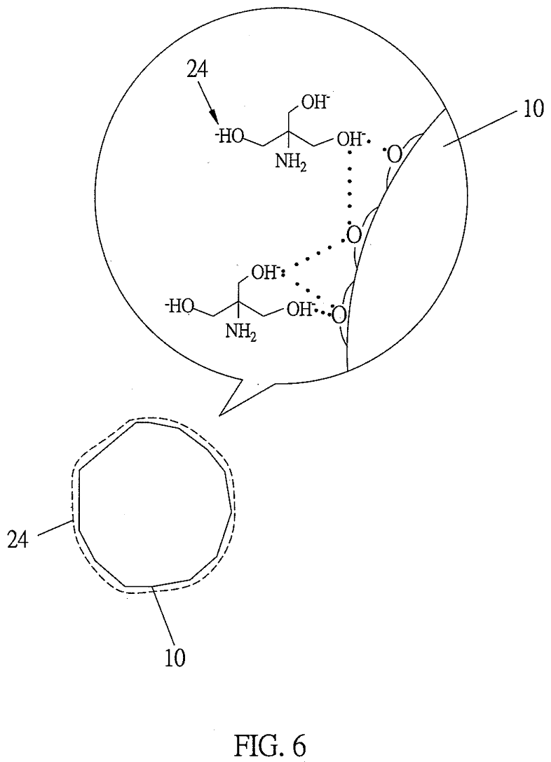

Step B: placing a tris (tris(hydroxymethyl)aminomethane, (HOCH₂)₃CNH₂) material 13 and a tris(hydroxymethyl)aminomethane hydrochloride (NH₂C(CH₂OH)₃·HCl) 14 into the wet mixer 500 for grinding and stirring with the first mixed slurry 10 to form a second mixed slurry 20 and to cause that an outer surface of each of the first LLZO particles 10 is coated with a hydroxide ion (OH⁻) layer 24. The hydroxide ion layer 24 has a plurality of third OH⁻ ions. Each of tris molecules in the tris material 13 and the tris(hydroxymethyl)aminomethane hydrochloride 14 has three OH⁻ ions which are a first OH⁻ ion, a second OH⁻ ion and the third OH⁻ ion. The first OH⁻ ions and the second OH⁻ ions of the tris molecules are bound to oxidizing functional groups on a corresponding first LLZO particle 10 by hydrogen bonding. The third OH⁻ ions of the tris molecules extend outward to an outer side of the corresponding first LLZO particle 10 to form the hydroxide ion layer 24 on the corresponding first LLZO particle 10 (as shown in FIG. 6). FIG. 6 shows an example of only two tris molecules and is not used to limit the scope of the present invention.

A ratio of a weight of the tris material 13 and a weight of the tris(hydroxymethyl)aminomethane hydrochloride 14 is 8:2.

In the step B, after the tris material 13 and the tris(hydroxymethyl)aminomethane hydrochloride 14 are placed into the wet mixer 500, a rotation speed of the wet mixer 500 is increased from the first rotation speed to a second rotation speed for grinding and stirring. That is, the second rotation speed is higher than the first rotation speed. In the step B, the second rotation speed of the wet mixer 500 is 2400 rpm±20%. A grinding and stirring time of the wet mixer 500 is 0.5 hour. An operation temperature of the wet mixer 500 is 20° C.±4° C.

The purpose of adding the tris(hydroxymethyl)aminomethane hydrochloride 14 is to control the pH value of the chemical reaction of the first LLZO particles 10 and the tris molecules. Because the chemical reaction of the first LLZO particles 10 and the tris molecules needs to be catalyzed under alkaline, however if the alkalinity is too high, it will also cause hydrolysis and deterioration of the first LLZO particles 10. Therefore, by adding the tris(hydroxymethyl)aminomethane hydrochloride 14, the pH value can be decreased to lower the alkalinity in the chemical reaction.

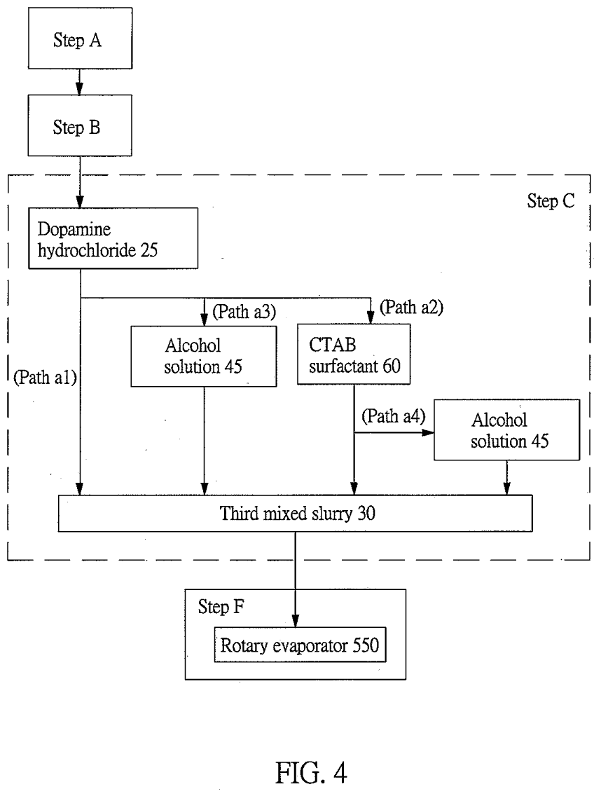

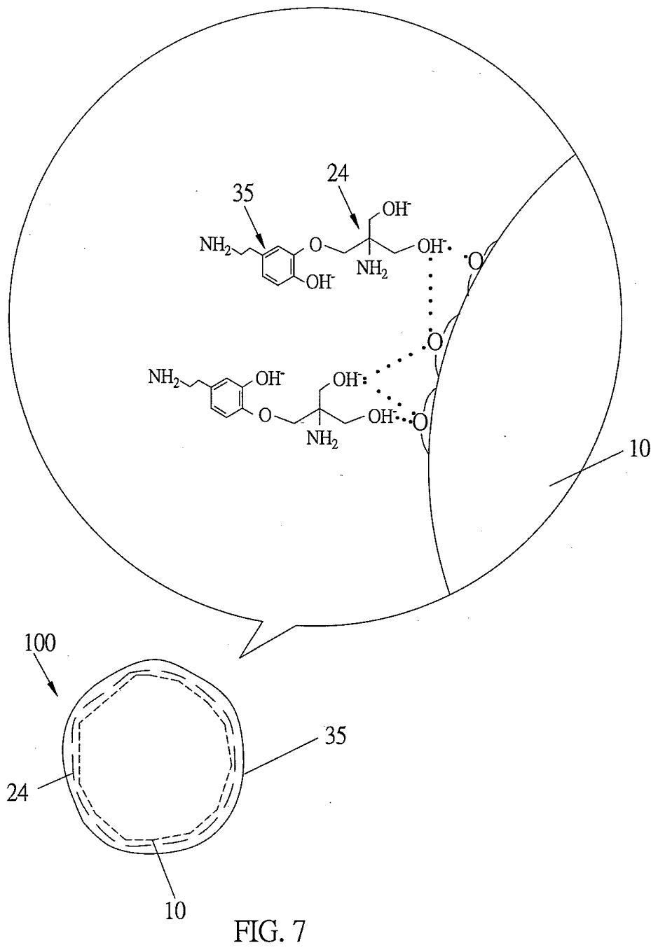

Step C: placing a dopamine hydrochloride ((HO)₂C₆H₃CH₂CH₂NH₂·HCl) 25 into the wet mixer 500 for mixing and grinding with the second mixed slurry 20 to form a third mixed slurry 30 which includes the composite LLZO particles 100 (as shown in the path al in FIG. 4). The dopamine hydrochloride 25 has a plurality of dopamine molecules. A polymerization triggered by dehydration is performed between OH⁻ ions of the dopamine molecules and the third OH⁻ ions of the hydroxide ion layer 24 on a corresponding first LLZO particle 10, which causes that each of the first LLZO particles 10 is bound to a plurality of corresponding dopamine molecules. The corresponding dopamine molecules are co-polymerized to form a dopamine layer 35 coated on an outer surface of the hydroxide ion layer 24 on the corresponding first LLZO particle 10. Each of the composite LLZO particles 100 is formed by a corresponding first LLZO particle 10, a corresponding hydroxide ion layer 24 and a corresponding dopamine layer 35 (as shown in FIG. 7). A thickness of the dopamine layer 35 is 1 nm˜10 nm.

A ratio of the total weight of the first LLZO particles 10, a total weight of the tris material 13 and the tris(hydroxymethyl)aminomethane hydrochloride 14 and a weight of the dopamine hydrochloride 25 is 1:0.8˜1:2.2˜2.4.

In the step C, the rotation speed of the wet mixer 500 is decreased from the second rotation speed to a third rotation speed. That is, the third rotation speed is lower than the second rotation speed. In the step C, the third rotation speed of the wet mixer 500 is 2000 rpm±20%. A mixing and grinding time of the wet mixer 500 is 0.5 to 1 hour. An operation temperature of the wet mixer 500 is 20° C.±4° C.

In the manufacturing of the electrode, because the first LLZO particles 10 are easy to perform a side reaction with the material in the electrode slurry to result in lower battery yields, a protective layer is needed to be coated on the outer side of the first LLZO particle 100 to prevent the first LLZO particles 10 perform the side reaction with the material in the electrode slurry. Because the dopamine molecules are hydrophobic, the dopamine hydrochloride 25 is added in the step C, which causes the dopamine molecules to form the dopamine layer 35 to be coated on the first LLZO particle 10 and prevent the first LLZO particle 10 from being dampened by water.

Referring to FIG. 4, in the step C, after the grinding and stirring of the dopamine hydrochloride 25 and the second mixed slurry 20, a CTAB (cetyltrimethylammonium bromide) surfactant 60 is further added into the third mixed slurry 30 in the wet mixer 500 and the mixing and grinding is continually performed by the wet mixer 500 at the third rotation speed for 10˜30 minutes (as shown in the path a2 in FIG. 4) to cause that a CTAB layer 61 is coated on an outer surface of the dopamine layer 35 of each of the first LLZO particles 10. The CTAB surfactant 60 has a plurality of CTAB molecules. A ratio of a weight of the CTAB surfactant 60 and the weight of the dopamine hydrochloride 25 is 0.1% to 0.3%.

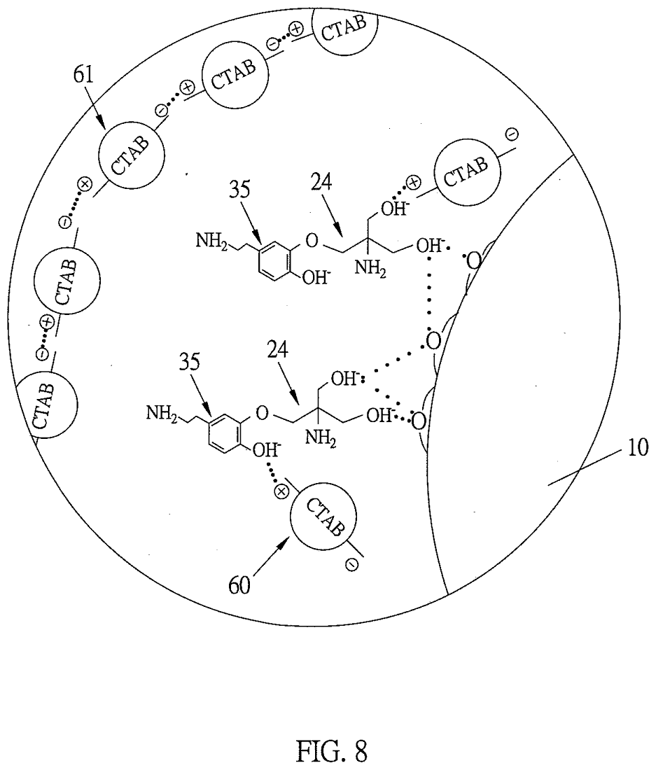

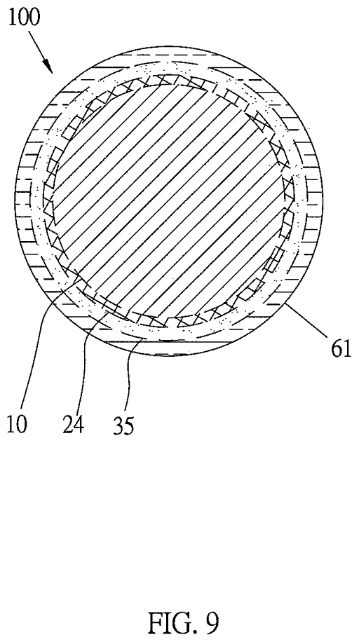

The purpose of adding the CTAB surfactant 60 is that, in the step C, on each of the composite LLZO particles 100, not all of the third OH⁻ ions of the hydroxide ion layer 24 and all of the OH⁻ ions of the dopamine molecules of the dopamine layer 35 perform the polymerization triggered by dehydration, therefore a plurality of exposed OH⁻ ions will be formed on a partial outer surface of each of the composite LLZO particles 100. Each of the exposed OH⁻ ions is the third OH⁻ ion of the hydroxide ion layer 24 or the OH⁻ ion of dopamine molecules of the dopamine layer 35. Each of the CTAB molecules in the CTAB surfactant 60 has two polarity ends which have a positive electric charge and a negative electric charge respectively. In the CTAB surfactant 60, polarity ends of a part of the CTAB molecules having a specific polarity (which has a positive electric charge) attract the exposed OH⁻ ions having an opposite polarity on a corresponding composite LLZO particle 100, which causes that the part of the CTAB molecules will be mixed within the dopamine layer 35 and the hydroxide ion layer 24 of the corresponding composite LLZO particle 100. A surplus of the CTAB molecules in the CTAB surfactant 60 is coated on the outer side of the dopamine layer 35 of each of the composite LLZO particle 100 by attractions formed between polarities of the surplus CTAB molecules (as shown in FIGS. 8 and 9). The CTAB layer 61 of each of the composite LLZO particle 100 is formed by the CTAB molecules mixed within the corresponding dopamine layer 35 and the corresponding hydroxide ion layer 24 and the CTAB molecules coated on the outer side of the corresponding dopamine layer 35.

With the CTAB layer 61, the composite LLZO particle 100 can have a better surface coating completeness and a higher disperstiveness, which prevents agglomeration of the composite LLZO particles 100 and reduces a chance of fluorination induced by interaction with Li between the first LLZO particles 10 and PVDF (polyvinylidene difluoride) in a positive electrode slurry. The structure of the CTAB molecules on the outer side of the dopamine layer 35 and the CTAB molecules mixed within the dopamine layer 35 and the hydroxide ion layer 24 is a naturally produced result in the manufacturing process.

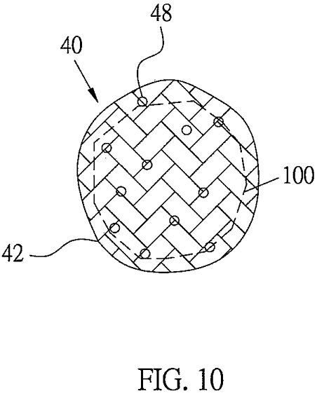

Referring to FIG. 4, in the step C, after the mixing and grinding of the dopamine hydrochloride 25 (path al in FIG. 4) or after the mixing and grinding the CTAB surfactant 60 added in the third mixed slurry 30 (path a2 in FIG. 4), an alcohol solution 45 including a plurality of carbon nanotubes 42 can be further added into the third mixed slurry 30 in the wet mixer 500 and the mixing and stirring is continually performed by the wet mixer 500 (as shown in the path a3 and path a4 in FIG. 4) to form a plurality of carbon-material-coated LLZO particles 40. Each of the carbon-material-coated LLZO particles 40 includes a corresponding composite LLZO particle 100 and a plurality of corresponding carbon nanotubes 42 wrapping around an outer side of the corresponding composite LLZO particle 100. Each of the carbon-material-coated LLZO particles 40 has a hairball-like structure (as shown in FIG. 10). After adding the alcohol solution 45, the rotation speed of the wet mixer 500 is 2000 rpm±20%, a mixing and grinding time of the wet mixer 500 is 0.5 hour and an operation temperature of the wet mixer 500 is 20° C.±4° C. Preferably, the alcohol solution 45 is a methanol solution.

A size of each of the carbon nanotubes 42 is 0.5 μm to 3 μm. A ratio of a weight of the alcohol solution 45 and a weight of the third mixed slurry 30 is 0.01˜0.5:100.

Step F: placing the third mixed slurry 30 having the composite LLZO particles 100 formed in the step C into a rotary evaporator 550 for removing most of liquid in the third mixed slurry 30 and unwanted residues, and then performing a drying by the rotary evaporator 550 to obtain a plurality of final powders.

After the step C, a size of each of the composite LLZO particles 100 is 50 nm to 200 nm.

The carbon nanotubes 42 serve to increase the electrical conductivity by forming a plurality of conductive bridges around various composite LLZO particles 100 for conducting the electron on the composite LLZO particles 100. The carbon nanotubes 42 have an extremely high electrical conductivity, so that lithium ions can pass through the carbon nanotubes 42 and conduct between the composite LLZO particles 100, which increase the electrical conductivity of the entire electrode.

The alcohol solution 45 further includes a plurality of nanoscale amorphous carbons 48. A size of each of nanoscale amorphous carbons 48 is 10 nm to 40 nm. Preferably, the nanoscale amorphous carbons 48 are amorphous carbons of a Super P auxiliary agent. The carbon nanotubes 42 and the nanoscale amorphous carbons 48 are used as an auxiliary agent. The nanoscale amorphous carbons 48 are in a form of particles and the carbon nanotubes 42 are in a form of long strips. The nanoscale amorphous carbons 45 are filled in a plurality of gaps formed by a interleaving structure formed by the carbon nanotubes 42 on the composite LLZO particles 100, which can transmit the electric charge between the carbon nanotubes 42 through the spanning of the nanoscale amorphous carbons 35, resulting in increasing the transmitting efficiency of the electric current.

The advantages of the present invention are that multiple mixing stages are used in the present invention to replace the conventional single mixing stage. In the prior art, the LLZO particles, tris (tris(hydroxymethyl)aminomethane) and dopamine hydrochloride are mixed in only one single stage, which does not have an adequate reaction and the dopamine coverage is also lower and cannot provide effective protection for the LLZO particles. Therefore, in the present invention, the mixing process is divided into multiple stages to extend the whole reaction time, which can make the LLZO particles have a smaller size and a larger surface area to effectively and fully react with the tris and dopamine hydrochloride. As a result, the surface of the LLZO particle can be completely coated with a solid dopamine layer form by the dopamine material to protect the LLZO particle from moisture erosion. The LLZO particles coated with the solid dopamine layer have a high lithium ion conductivity and no reaction will be formed between the water and the LLZO particles in the manufacturing process of electrodes, which achieves a better manufacturing quality of the battery electrode material.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing oxide particles coated with amino groups, wherein the oxide particles are a plurality of composite LLZO particles; the method comprising the steps of:
step A: placing a plurality of first LLZO particles and a methanol into a wet mixer for mixing and grinding at a first rotation speed to form a first mixed slurry; wherein the wet mixer has a plurality of zirconium balls for mixing and grinding to cause that the size of each of the first LLZO particles is smaller than 500 nm;
step B: placing a tris (tris(hydroxymethyl)aminomethane, (HOCH₂)₃CNH₂) material and a tris(hydroxymethyl)aminomethane hydrochloride (NH₂C(CH₂OH)₃·HCl) into the wet mixer for grinding and stirring with the first mixed slurry to form a second mixed slurry and to cause that an outer surface of each of the first LLZO particles is coated with a hydroxide ion layer; wherein the hydroxide ion layer has a plurality of third OH⁻ ions; each of tris molecules in the tris material and the tris(hydroxymethyl)aminomethane hydrochloride has three OH⁻ ions which are a first OH⁻ ion, a second OH⁻ ion and the third OH⁻ ion; the first OH⁻ ions and the second OH⁻ ions of the tris molecules are bound to oxidizing functional groups on a corresponding first LLZO particle; and the third OH⁻ ions of the tris molecules extend outward to an outer side of the corresponding first LLZO particle to form the hydroxide ion layer on the corresponding first LLZO particle;
wherein in the step B, after the tris material and the tris(hydroxymethyl)aminomethane hydrochloride are placed into the wet mixer, a rotation speed of the wet mixer is increased from the first rotation speed to a second rotation speed for grinding and stirring;
step C: placing a dopamine hydrochloride ((HO)₂C₆H₃CH₂CH₂NH₂·HCl) into the wet mixer for mixing and grinding with the second mixed slurry to form a third mixed slurry which includes the composite LLZO particles; wherein the dopamine hydrochloride has a plurality of dopamine molecules; a polymerization triggered by dehydration is performed between OH⁻ ions of the dopamine molecules and the third OH⁻ ions of the hydroxide ion layer on a corresponding first LLZO particle, which causes that each of the first LLZO particles is bound to a plurality of corresponding dopamine molecules; the corresponding dopamine molecules are co-polymerized to form a dopamine layer coated on an outer surface of the hydroxide ion layer on the corresponding first LLZO particle; and each of the composite LLZO particles is formed by a corresponding first LLZO particle, a corresponding hydroxide ion layer and a corresponding dopamine layer; and
wherein in the step C, the rotation speed of the wet mixer is decreased from the second rotation speed to a third rotation speed.

2. The method for manufacturing the oxide particles coated with the amino groups as claimed in claim 1, wherein in the step C, after the grinding and stirring of the dopamine hydrochloride and the second mixed slurry, a CTAB (cetyltrimethylammonium bromide) surfactant is added into the third mixed slurry in the wet mixer and the mixing and grinding is continually performed by the wet mixer to cause that a CTAB layer is coated on an outer surface of the dopamine layer of each of the first LLZO particles; and the CTAB surfactant has a plurality of CTAB molecules; and
wherein in the step C, a plurality of exposed OH⁻ ions are formed on a partial outer surface of each of the composite LLZO particles; each of the exposed OH⁻ ions is the third OH⁻ ion of the hydroxide ion layer or the OH⁻ ion of dopamine molecules of the dopamine layer; each of the CTAB molecules in the CTAB surfactant has two polarity ends which have a positive electric charge and a negative electric charge respectively; in the CTAB surfactant, the polarity ends of a part of the CTAB molecules having a specific polarity attract the exposed OH⁻ ions having an opposite polarity on a corresponding composite LLZO particle, which causes that the part of the CTAB molecules is mixed within the dopamine layer and the hydroxide ion layer of the corresponding composite LLZO particle; a surplus of the CTAB molecules in the CTAB surfactant is coated on the outer side of the dopamine layer of each of the composite LLZO particle by attractions formed between polarities of the surplus CTAB molecules; and the CTAB layer of each of the composite LLZO particle is formed by the CTAB molecules mixed within the corresponding dopamine layer and the corresponding hydroxide ion layer and the CTAB molecules coated on the outer side of the corresponding dopamine layer.

3. The method for manufacturing the oxide particles coated with the amino groups as claimed in claim 1, wherein in the step C, after the mixing and grinding of the dopamine hydrochloride, an alcohol solution including a plurality of carbon nanotubes is added into the third mixed slurry in the wet mixer and the mixing and stirring is continually performed by the wet mixer to form a plurality of carbon-material-coated LLZO particles; and each of the carbon-material-coated LLZO particles includes a corresponding composite LLZO particle and a plurality of corresponding carbon nanotubes wrapping around an outer side of the corresponding composite LLZO particle.

4. The method for manufacturing the oxide particles coated with the amino groups as claimed in claim 2, wherein in the step C, after the mixing and grinding of the CTAB surfactant added in the third mixed slurry, an alcohol solution including a plurality of carbon nanotubes is added into the third mixed slurry in the wet mixer and the mixing and stirring is continually performed by the wet mixer to form a plurality of carbon-material-coated LLZO particles; and each of the carbon-material-coated LLZO particles includes a corresponding composite LLZO particle and a plurality of corresponding carbon nanotubes wrapping around an outer side of the corresponding composite LLZO particle.

5. The method for manufacturing the oxide particles coated with the amino groups as claimed in claim 1, further comprising the steps of:
step F: placing the third mixed slurry having the composite LLZO particles formed in the step C into a rotary evaporator for removing most of liquid in the third mixed slurry and unwanted residues, and then performing a drying by the rotary evaporator to obtain a plurality of final powders.

6. The method for manufacturing the oxide particles coated with the amino groups as claimed in claim 3, wherein the alcohol solution further includes a plurality of nanoscale amorphous carbons; a size of each of nanoscale amorphous carbons is 10 nm to 40 nm; the nanoscale amorphous carbons are filled in the a plurality of gaps formed by a interleaving structure formed by the carbon nanotubes on the composite LLZO particles.

7. The method for manufacturing the oxide particles coated with the amino groups as claimed in claim 4, wherein the alcohol solution further includes a plurality of nanoscale amorphous carbons; a size of each of nanoscale amorphous carbons is 10 nm to 40 nm; the nanoscale amorphous carbons are filled in the a plurality of gaps formed by a interleaving structure formed by the carbon nanotubes on the composite LLZO particles.

8. The method for manufacturing the oxide particles coated with the amino groups as claimed in claim 2, wherein a ratio of a weight of the CTAB surfactant and a weight of the dopamine hydrochloride is 0.1% to 0.3%.

9. The method for manufacturing the oxide particles coated with the amino groups as claimed in claim 3, wherein a size of each of the carbon nanotubes is 0.5 μm to 3 μm.

10. The method for manufacturing the oxide particles coated with the amino groups as claimed in claim 4, wherein a size of each of the carbon nanotubes is 0.5 μm to 3 μm.

11. The method for manufacturing the oxide particles coated with the amino groups as claimed in claim 3, wherein a ratio of a weight of the alcohol solution and a weight of the third mixed slurry is 0.01˜0.5:100; and the alcohol solution is a methanol solution.

12. The method for manufacturing the oxide particles coated with the amino groups as claimed in claim 4, wherein a ratio of a weight of the alcohol solution and a weight of the third mixed slurry is 0.01˜0.5:100; and the alcohol solution is a methanol solution.

13. The method for manufacturing the oxide particles coated with the amino groups as claimed in claim 1, wherein the composite LLZO particles are used in the electrode is a positive electrode.

14. The method for manufacturing the oxide particles coated with the amino groups as claimed in claim 1, wherein each of the first LLZO particles is formed by LLZO (lithium lanthanum zirconium oxide, Li₇La₃Zr₂O₁₂) or LLZO doped with at least one metal (such as gallium(Ga)-doped LLZO (Li_{6.2}Ga_{0.8}La₃Zr₂O₁₂), aluminum(Al)-doped LLZO or barium(Ba)-doped LLZO.

15. The method for manufacturing the oxide particles coated with the amino groups as claimed in claim 1, wherein before the mixing and grinding of the wet mixer in the step A, a size of each of the first LLZO particles is 2 μm˜10 μm; and each of the first LLZO particles is a cube having an irregular three-dimensional shape.

16. The method for manufacturing the oxide particles coated with the amino groups as claimed in claim 1, wherein in the step A, a ratio of a total weight of the first LLZO particles and a weight of the methanol is 0.8˜1.2:4;
wherein in the step B, a ratio of a weight of the tris material and a weight of the tris(hydroxymethyl)aminomethane hydrochloride is 8:2;
wherein in the step C, a ratio of the total weight of the first LLZO particles, a total weight the tris material and the tris(hydroxymethyl)aminomethane hydrochloride and a weight of the dopamine hydrochloride is 1:0.8˜1:2.2˜2.4; and
wherein a thickness of the dopamine layer is 1 nm˜10 nm.

17. The method for manufacturing the oxide particles coated with the amino groups as claimed in claim 1, wherein in the step A, the first rotation speed of the wet mixer is 2200 rpm±20%; each of the first zirconium balls has a grain size of 0.7 mm to 0.9 mm; a filling ratio of a total volume of the zirconium balls is 70% to 90%, which is a ratio of the total volume of the zirconium balls to a grinding volume of the wet mixer; a mixing and grinding time of the wet mixer is 1 to 1.5 hours; an operation temperature of wet mixer is 20° C.±4° C;
wherein in the step B, the second rotation speed of the wet mixer is 2400 rpm±20%; the grinding and stirring time of the wet mixer is 0.5 hour; and the operation temperature of the wet mixer is 20° C.±4° C.; and
wherein in the step C, the third rotation speed of the wet mixer is 2000 rpm±20%; the mixing and grinding time of the wet mixer is 0.5 to 1 hour; and the operation temperature of the wet mixer is 20° C.±4° C.

18. The method for manufacturing the oxide particles coated with the amino groups as claimed in claim 2, wherein in the step C, the third rotation speed of the wet mixer is 2000 rpm±20%; and after adding the CTAB surfactant, the mixing and grinding is continually performed by the wet mixer at the third rotation speed for 10˜30 minutes.

19. The method for manufacturing the oxide particles coated with the amino groups as claimed in claim 3, wherein in the step C, the third rotation speed of the wet mixer is 2000 rpm±20%; and after adding the alcohol solution, the mixing and stirring is continually performed by the wet mixer for 0.5 hour and an operation temperature of the wet mixer is 20° C.±4° C.

20. The method for manufacturing the oxide particles coated with the amino groups as claimed in claim 4, wherein in the step C, the third rotation speed of the wet mixer is 2000 rpm±20%; and after adding the alcohol solution, the mixing and stirring is continually performed by the wet mixer for 0.5 hour and an operation temperature of the wet mixer is 20° C.±4° C.
